(19) United States
(12) Patent Application Publication
(10) Pub. No.: US 2014/0055659 A1
(43) Pub. Date: Feb. 27, 2014

(54) ZOOM LENS AND IMAGE PICKUP APPARATUS

(71) Applicant: CANON KABUSHIKI KAISHA, Tokyo (JP)

(72) Inventor: Shunji Iwamoto, Utsunomiya-shi (JP)

(21) Appl. No.: 13/966,715

(22) Filed: Aug. 14, 2013

(30) Foreign Application Priority Data
Aug. 22, 2012 (JP) 2012-183147

(51) Int. Cl. G02B 15/14; H04N 5/232

(52) U.S. Cl. CPC G02B 15/14; H04N 5/232
USPC 348/335; 359/686

(57) ABSTRACT

The zoom lens includes first to fourth lens units respectively having negative, positive, negative and positive refractive powers and being moved during zooming. The first lens unit includes 1-1 and 1-2 negative lenses each having a meniscus shape with an object side convex surface. The conditions of −4.0<f11/fw<−1.5,1.5<(R11b+R11a)/(R11b−R11a)<5.0 and 1.4<h12/D12<2.0 are satisfied where f11 represents a focal length of the 1-1 lens, fw represents a focal length of the zoom lens at a wide-angle end, R11a and R11b respectively represent curvature radii of the object side surface and an image side concave surface of the 1-1 lens, h12 represents half of an effective diameter of an image side aspheric surface of the 1-2 lens, and D12 represents a distance from an effective diameter position in the image side surface of the 1-2 lens to an apex of the image side aspheric surface thereof.

### BACKGROUND OF THE INVENTION

1. Field of the Invention

The present invention relates to a zoom lens suitable for image pickup apparatuses such as digital still cameras, video cameras, surveillance cameras, television cameras and silver-haloid film cameras.

2. Description of the Related Art

Image capturing optical systems used as zoom lenses for image capturing each require that various aberrations be corrected well, its resolution be high from a central image area to a peripheral image area, its angle of view be large and its size be compact by decreasing its front lens diameter.

In negative-lead zoom lenses whose most-object side lens unit has a negative refractive power, it is relatively easy to increase the angle of view while securing a desired zoom ratio and decreasing size of the entire zoom lens.

In such negative-lead zoom lenses having an increased angle of view, off-axis rays generally have a large angle with respect to an optical axis. Therefore, at the most-object side lens unit having the negative refractive power, an incident height of the off-axis rays becomes high at a wide-angle end of the zoom lens. As a result, an inappropriate lens configuration of a front (first) lens unit (for example, an inappropriate shape of a lens having a negative refractive power) increases off-axis aberrations such as distortion, field curvature and astigmatism at the wide-angle end, which makes it difficult to correct the various off-axis aberrations.

U.S. Pat. No. 7,593,171 discloses a four-lens-unit zoom lens which includes a first lens unit having a negative refractive power, a second lens unit having a positive refractive power, a third lens unit having a negative refractive power and a fourth lens unit having a positive refractive power and in which the first to fourth lens units are moved during zooming.

Japanese Patent Laid-Open No. 2007-94174 discloses a two-lens unit zoom lens including a first lens unit having a negative refractive power and a second lens unit having a positive refractive power and in which the first and second lens units are moved during zooming.

### SUMMARY OF THE INVENTION

The present invention provides a zoom lens having a wide angle of view and achieving high optical performance in its entire zoom range.

The present invention provides as an aspect thereof a zoom lens including, in order from an object side to an image side, a first lens unit having a negative refractive power, a second lens unit having a positive refractive power, a third lens unit having a negative refractive power; and a fourth lens unit having a positive refractive power. Distances between mutually adjacent lens units among the first to fourth lens units change during zooming. The first lens unit includes, in order from the object side to the image side, a 1-1 lens having a meniscus shape whose convex surface faces the object side and having a negative refractive power, and a 1-2 lens having a meniscus shape whose convex surface faces the object side and having a negative refractive power, an image side surface of the 1-2 lens being formed in an aspheric shape that decreases a negative refractive power from its center toward periphery. The following conditions are satisfied:

−4.0<f11/fw<−1.5

1.5<(R11b+R11a)/(R11b−R11a)<5.0

1.4<h12/D12<2.0

where f11 represents a focal length of the 1-1 lens, fw represents a focal length of the entire zoom lens at a wide-angle end, R11a and R11b respectively represent curvature radii of the object side convex surface and an image side concave surface of the 1-1 lens, h12 represents half of an effective diameter of the image side aspheric surface of the 1-2 lens, and D12 represents a distance in an optical axis direction from an effective diameter position in the image side aspheric surface of the 1-2 lens to an apex of the image side aspheric surface of the 1-2 lens.

The present invention provides as another aspect thereof an image pickup apparatus including the above zoom lens, and an image sensor receiving an object image formed by the zoom lens.

Further features of the present invention will become apparent from the following description of exemplary embodiments with reference to the attached drawings.

### BRIEF DESCRIPTION OF THE DRAWINGS

FIGS. 1A and 1B are sectional views of a zoom lens that is Embodiment 1 at a wide-angle end and at a telephoto end, respectively.

FIGS. 2A, 2B and 2C are aberration charts of the zoom lens of Embodiment 1 in a state where the zoom lens is focused on an infinite object at the wide-angle end, at a middle zoom position and at the telephoto end, respectively.

FIGS. 3A and 3B are sectional views of a zoom lens that is Embodiment 2 at a wide-angle end and at a telephoto end, respectively.

FIGS. 4A, 4B and 4C are aberration charts of the zoom lens of Embodiment 2 in a state where the zoom lens is focused on an infinite object at the wide-angle end, at a middle zoom position and at the telephoto end, respectively.

FIGS. 5A and 5B are sectional views of a zoom lens that is Embodiment 3 at a wide-angle end and at a telephoto end, respectively.

FIGS. 6A, 6B and 6C are aberration charts of the zoom lens of Embodiment 3 in a state where the zoom lens is focused on an infinite object at the wide-angle end, at a middle zoom position and at the telephoto end, respectively.

FIGS. 7A and 7B are sectional views of a zoom lens that is Embodiment 4 at a wide-angle end and at a telephoto end, respectively.

FIGS. 8A, 8B and 8C are aberration charts of the zoom lens of Embodiment 4 in a state where the zoom lens is focused on an infinite object at the wide-angle end, at a middle zoom position and at the telephoto end, respectively.

FIGS. 9A and 9B are sectional views of a zoom lens that is Embodiment 5 at a wide-angle end and at a telephoto end, respectively.

FIGS. 10A, 10B and 10C are aberration charts of the zoom lens of Embodiment 5 in a state where the zoom lens is focused on an infinite object at the wide-angle end, at a middle zoom position and at the telephoto end, respectively.

FIGS. 11A and 11B are sectional views of a zoom lens that is Embodiment 6 at a wide-angle end and at a telephoto end, respectively.

FIGS. 12A, 12B and 12C are aberration charts of the zoom lens of Embodiment 6 in a state where the zoom lens is focused on an infinite object at the wide-angle end, at a middle zoom position and at the telephoto end, respectively.

FIG. 13 shows a camera (image pickup apparatus) provided with the zoom lens of one of Embodiments 1 to 6.

### DESCRIPTION OF THE EMBODIMENTS

Exemplary embodiments of the present invention will hereinafter be described with reference to the accompanying drawings.

Zoom lenses of the following embodiments of the present invention each include, in order from an object side to an image side, a first lens unit having a negative refractive power, a second lens unit having a positive refractive power, a third lens unit having a negative refractive power, and a fourth lens unit having a positive refractive power. In the zoom lens, distances in a direction of an optical axis (hereinafter referred to as “an optical axis direction”) between mutually adjacent lens units among the first to fourth lens units change during zooming.

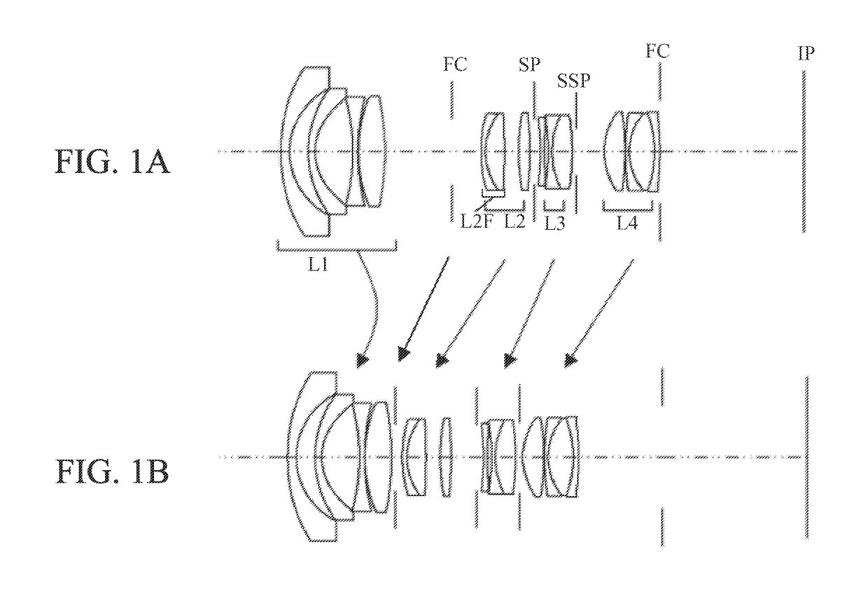

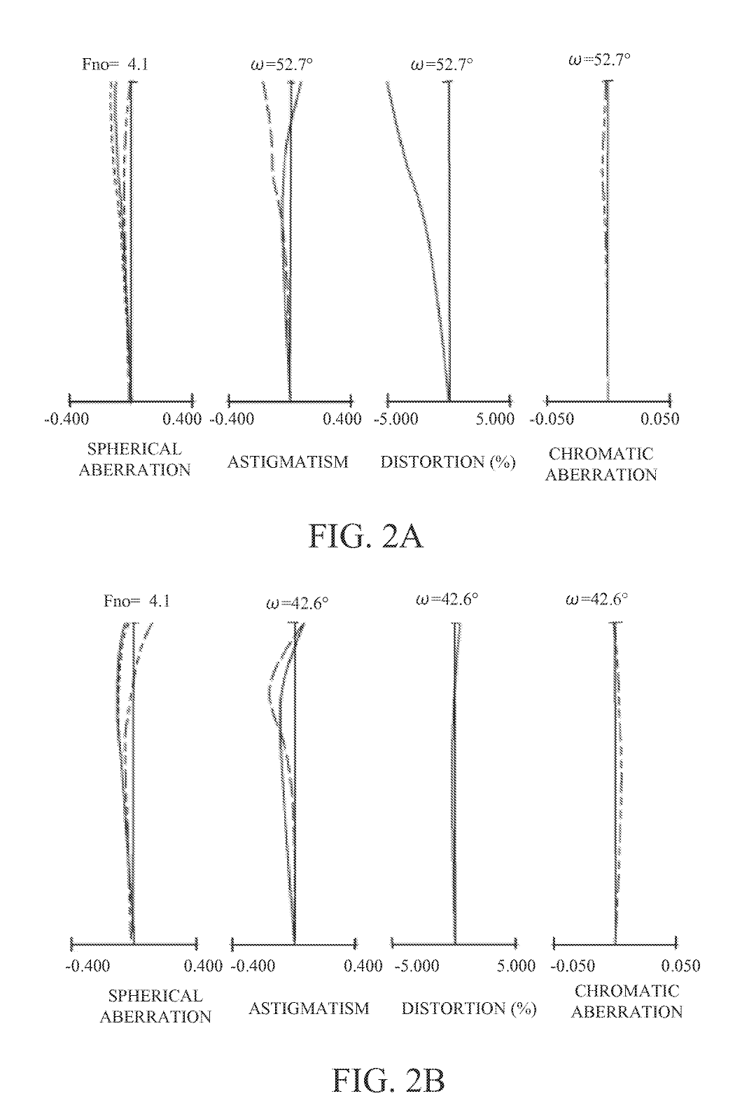

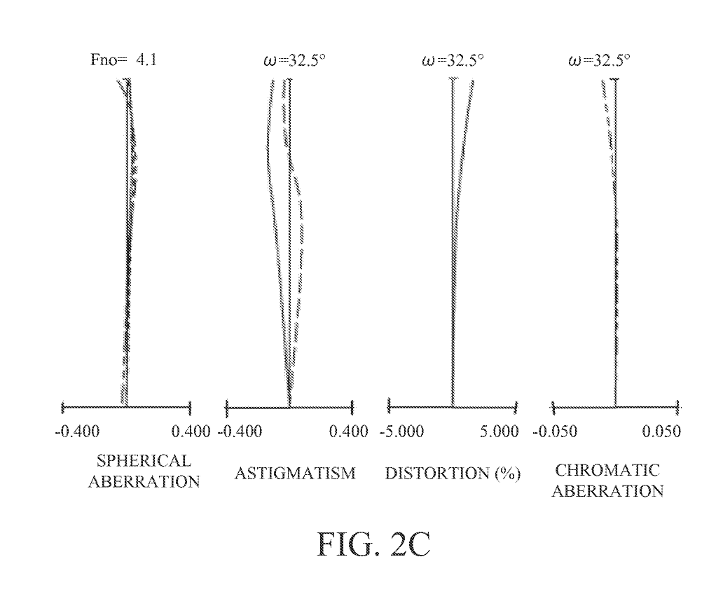

FIGS. 1A and 1B are sectional views of the zoom lens that is a first embodiment (Embodiment 1) at a wide-angle end (shortest focal length end) and at a telephoto end (longest focal length end), respectively. FIGS. 2A, 2B and 2C are aberration charts of the zoom lens of Embodiment 1 in a state where the zoom lens is focused on an infinite object at the wide-angle end, at a middle zoom position and at the telephoto end, respectively. The zoom lens has a zoom ratio of 2.06, an image capturing angle of view of 105.36° and an F-number of 4.10.

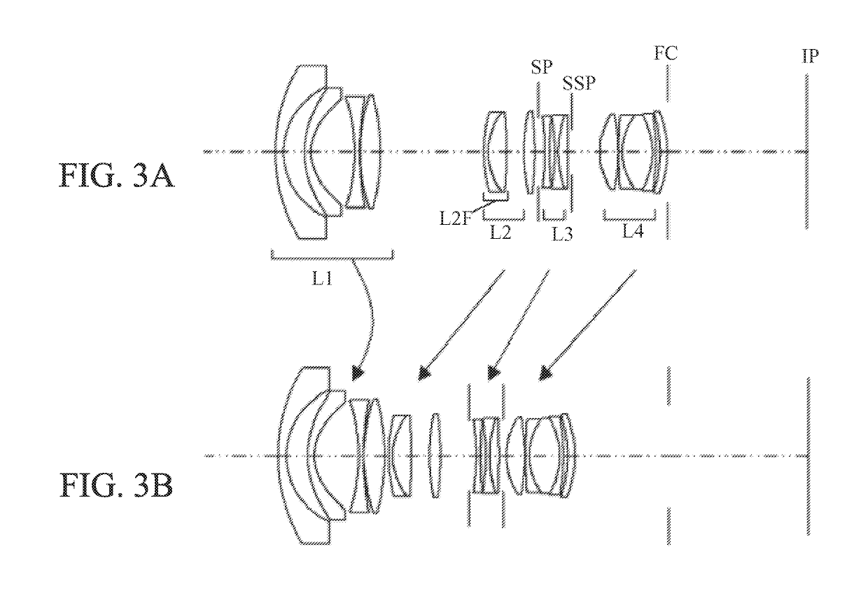

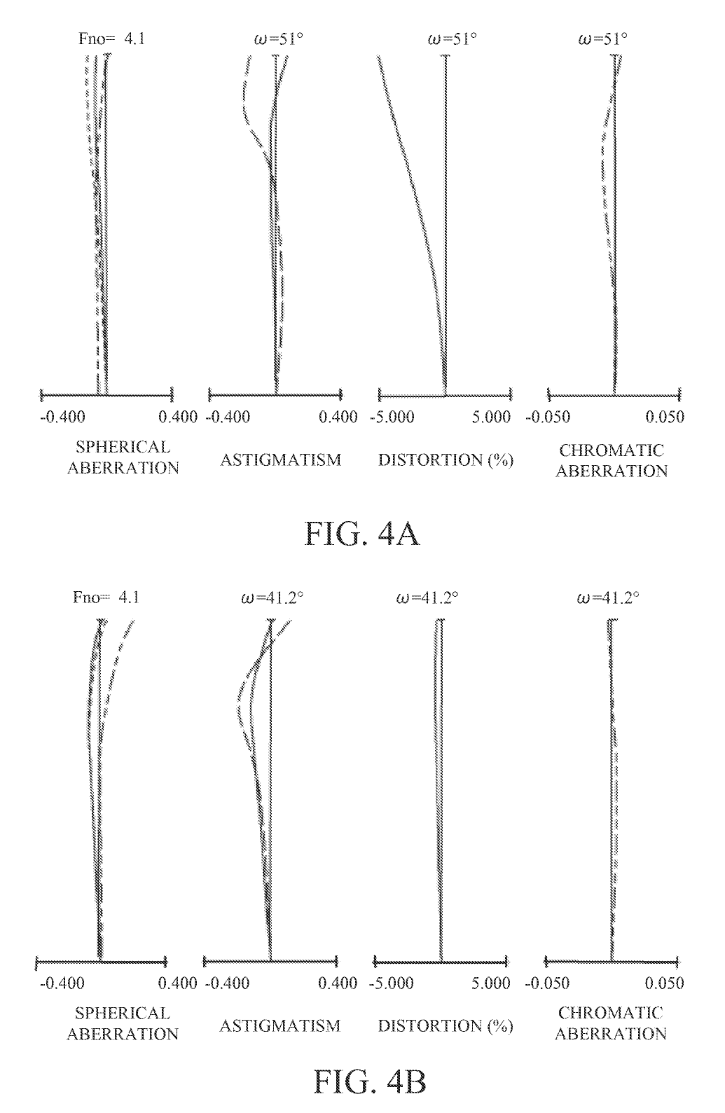

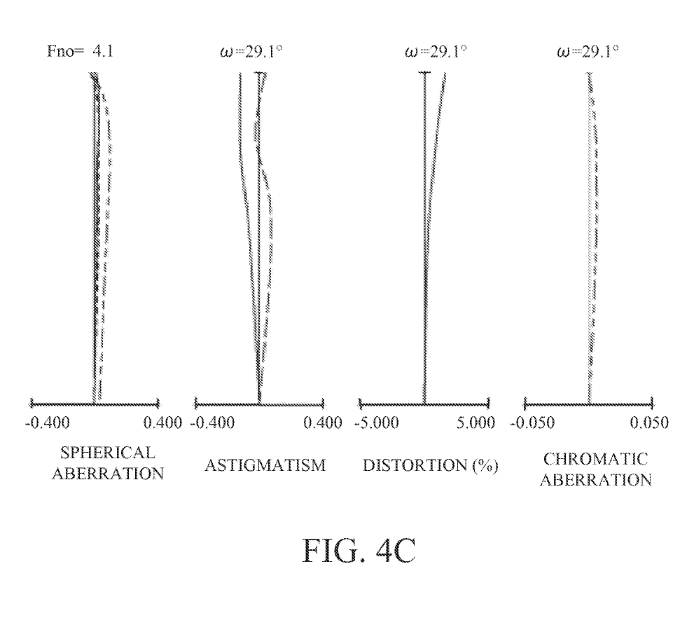

FIGS. 3A and 3B are sectional views of the zoom lens that is a second embodiment (Embodiment 2) at a wide-angle end and at a telephoto end, respectively. FIGS. 4A, 4B and 4C are aberration charts of the zoom lens of Embodiment 2 in a state where the zoom lens is focused on an infinite object at the wide-angle end, at a middle zoom position and at the telephoto end, respectively. The zoom lens has a zoom ratio of 2.22, an image capturing angle of view of 102.06° and an F-number of 4.10.

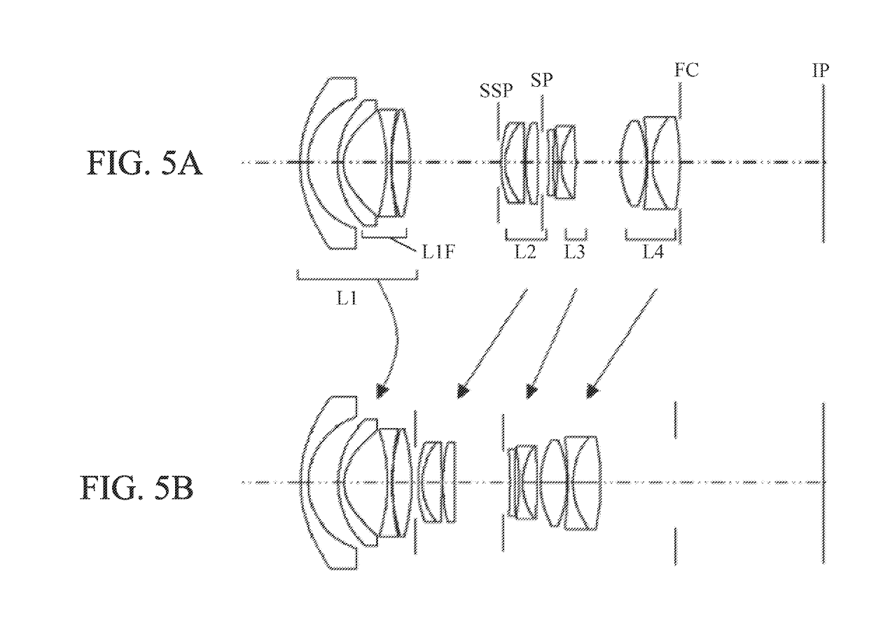

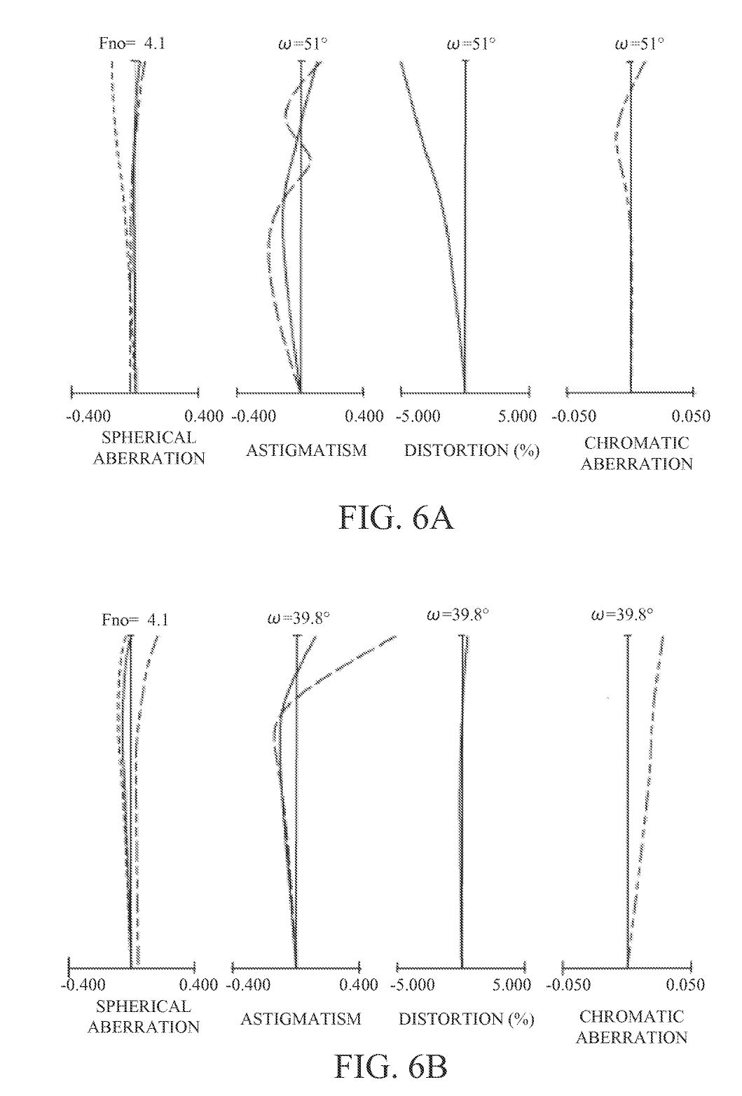

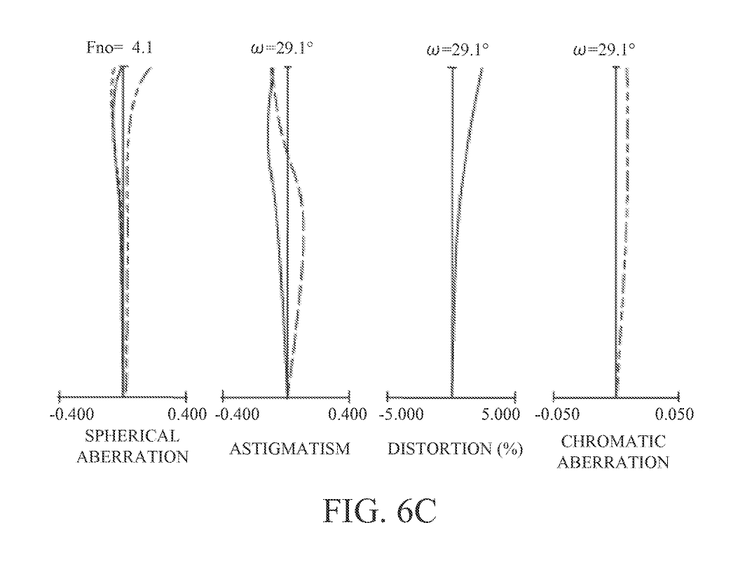

FIGS. 5A and 5B are sectional views of the zoom lens that is a third embodiment (Embodiment 3) at a wide-angle end and at a telephoto end, respectively. FIGS. 6A, 6B and 6C are aberration charts of the zoom lens of Embodiment 3 in a state where the zoom lens is focused on an infinite object at the wide-angle end, at a middle zoom position and at the telephoto end, respectively. The zoom lens has a zoom ratio of 2.22, an image capturing angle of view of 102.04° and an F-number of 4.10.

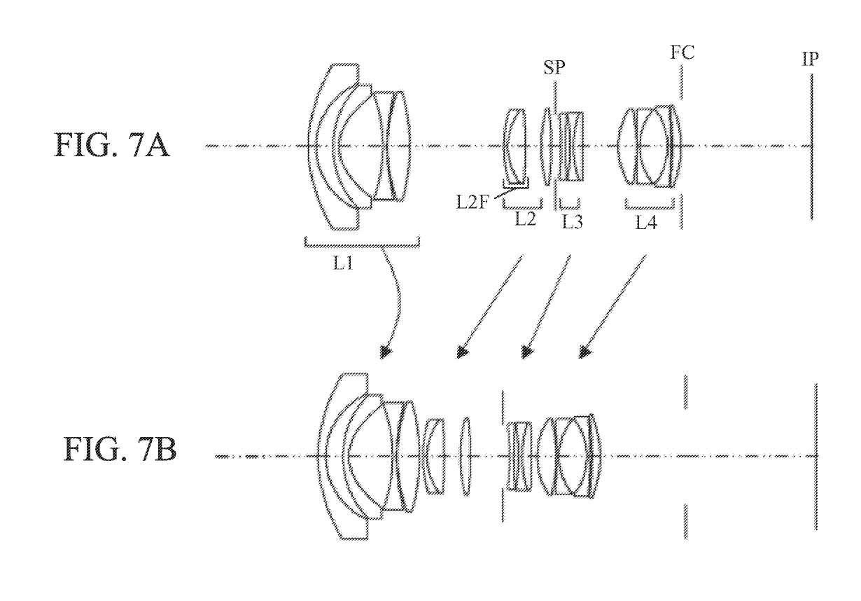

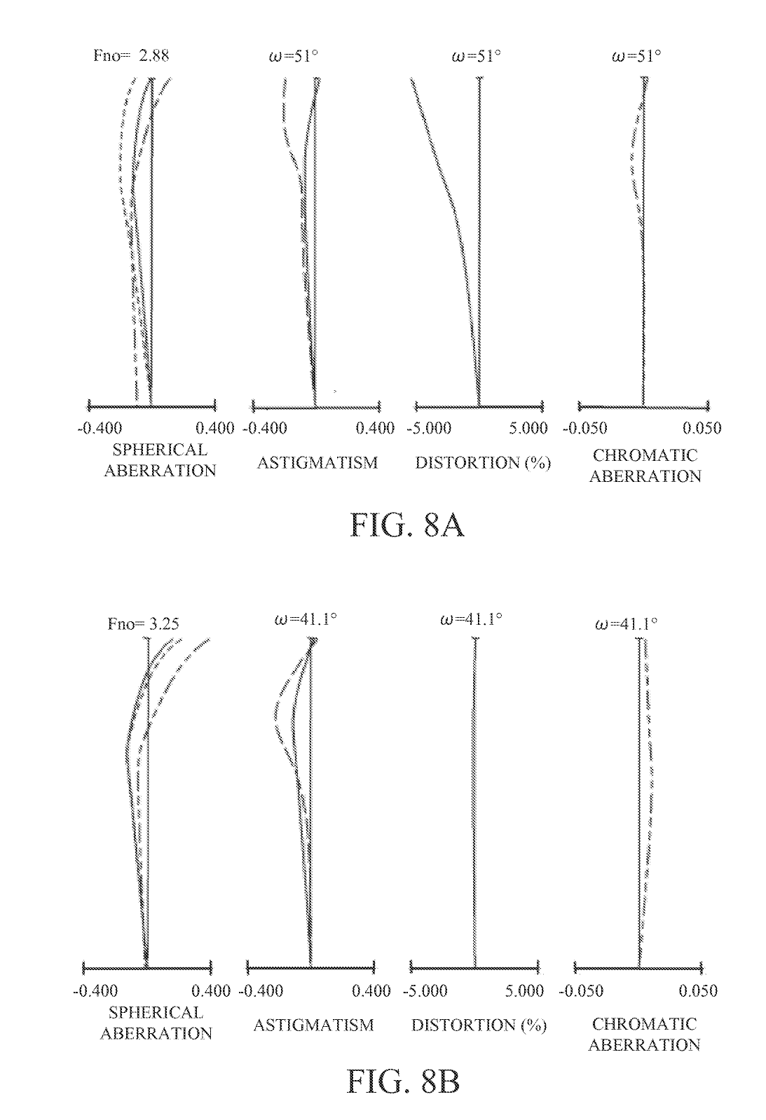

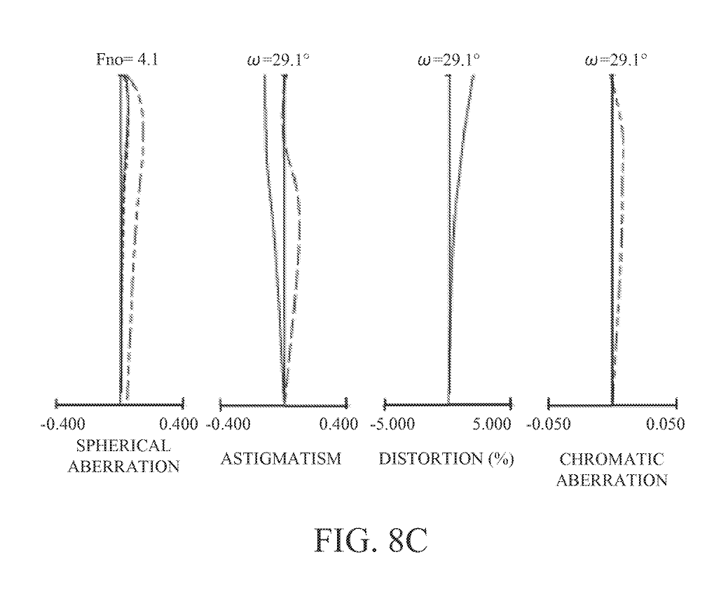

FIGS. 7A and 7B are sectional views of the zoom lens that is a fourth embodiment (Embodiment 4) at a wide-angle end and at a telephoto end, respectively. FIGS. 8A, 8B and 8C are aberration charts of the zoom lens of Embodiment 4 in a state where the zoom lens is focused on an infinite object at the wide-angle end, at a middle zoom position and at the telephoto end, respectively. The zoom lens has a zoom ratio of 2.22, an image capturing angle of view of 102.04° and an F-number from 2.88 to 4.10.

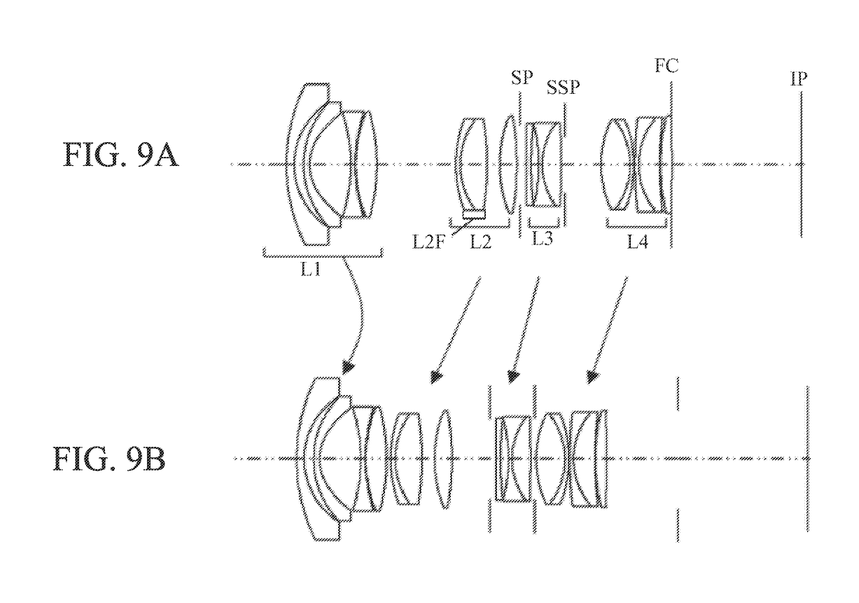

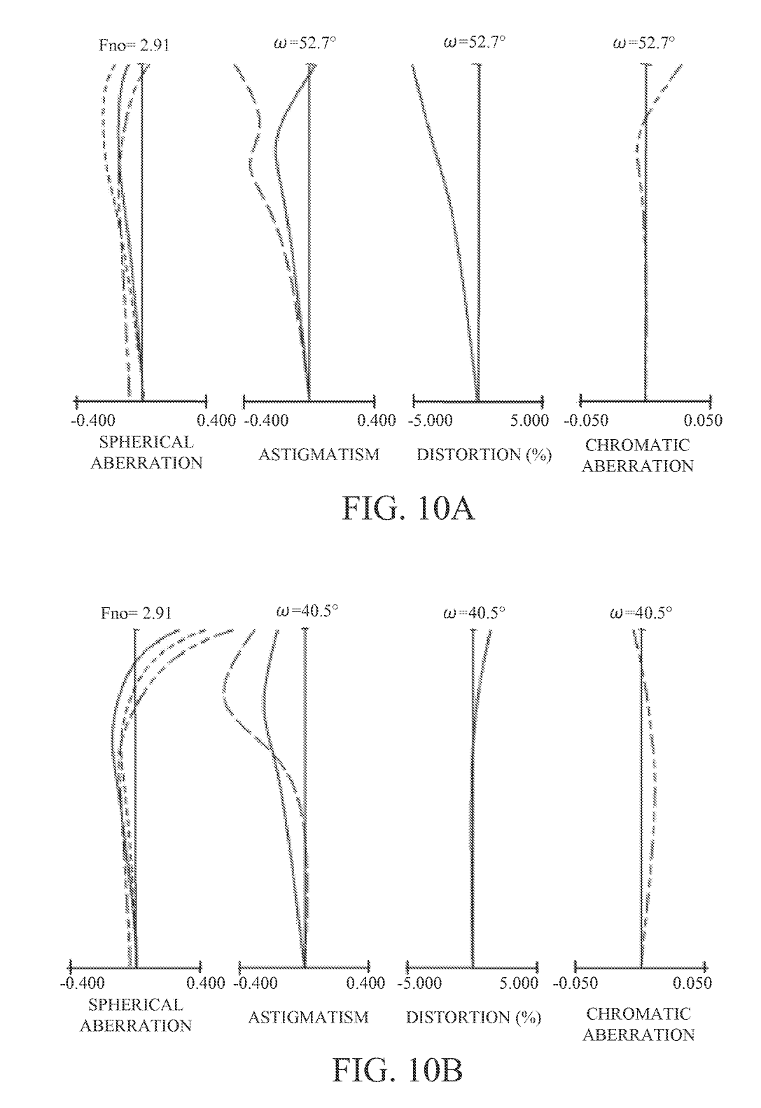

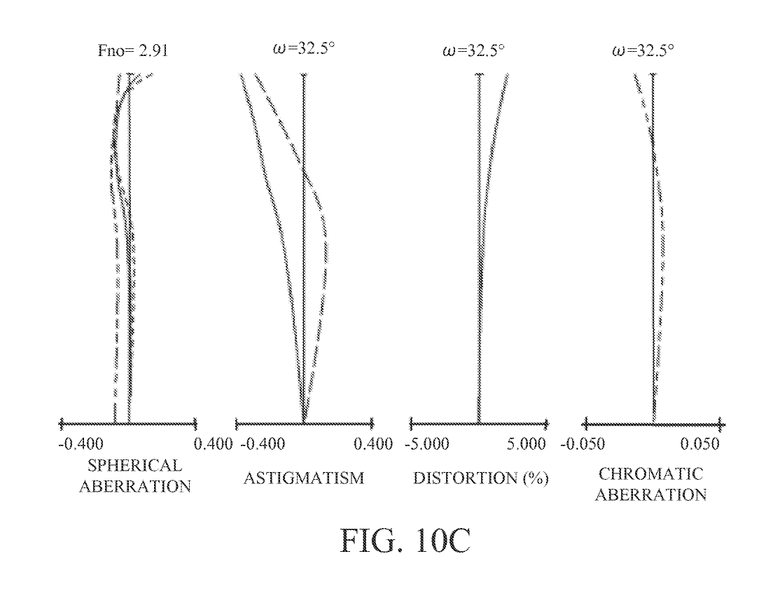

FIGS. 9A and 9B are sectional views of the zoom lens that is a fifth embodiment (Embodiment 5) at a wide-angle end and at a telephoto end, respectively. FIGS. 10A, 10B and 10C are aberration charts of the zoom lens of Embodiment 5 in a state where the zoom lens is focused on an infinite object at the wide-angle end, at a middle zoom position and at the telephoto end, respectively. The zoom lens has a zoom ratio of 2.06, an image capturing angle of view of 105.32° and an F-number of 2.91.

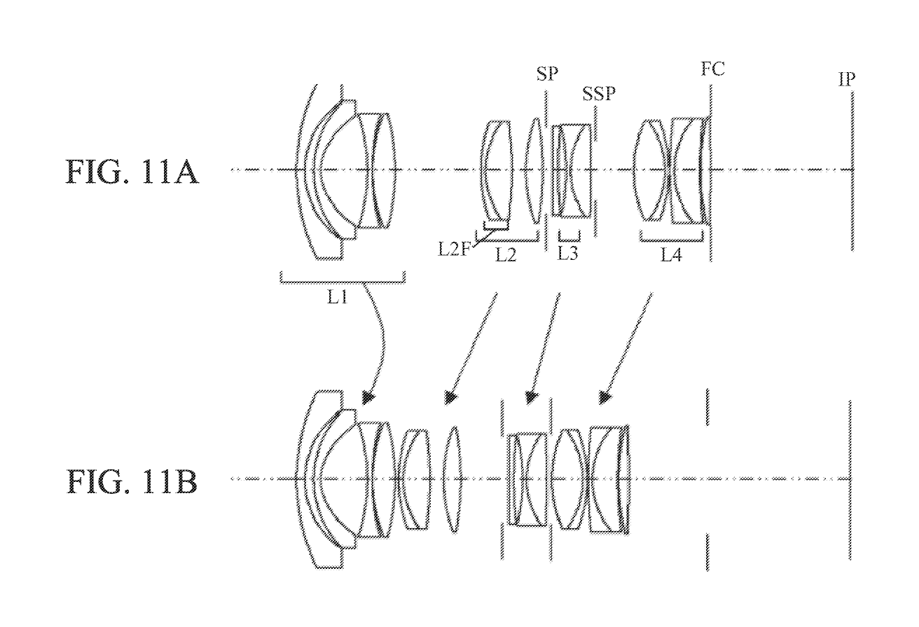

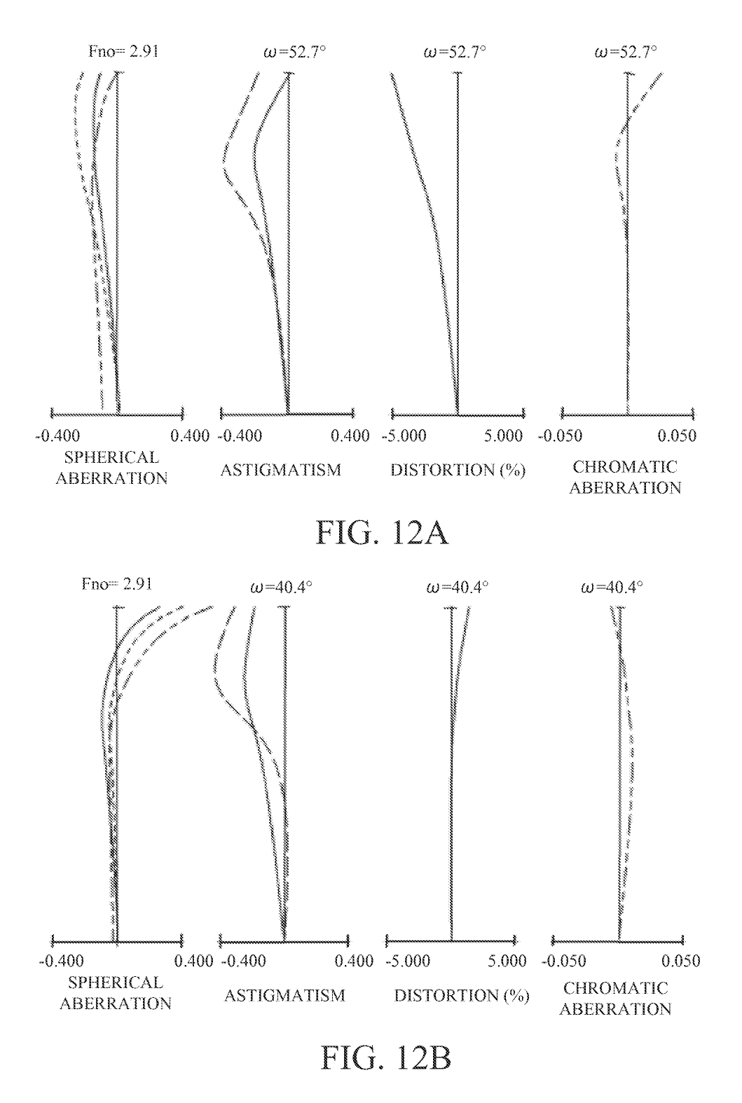

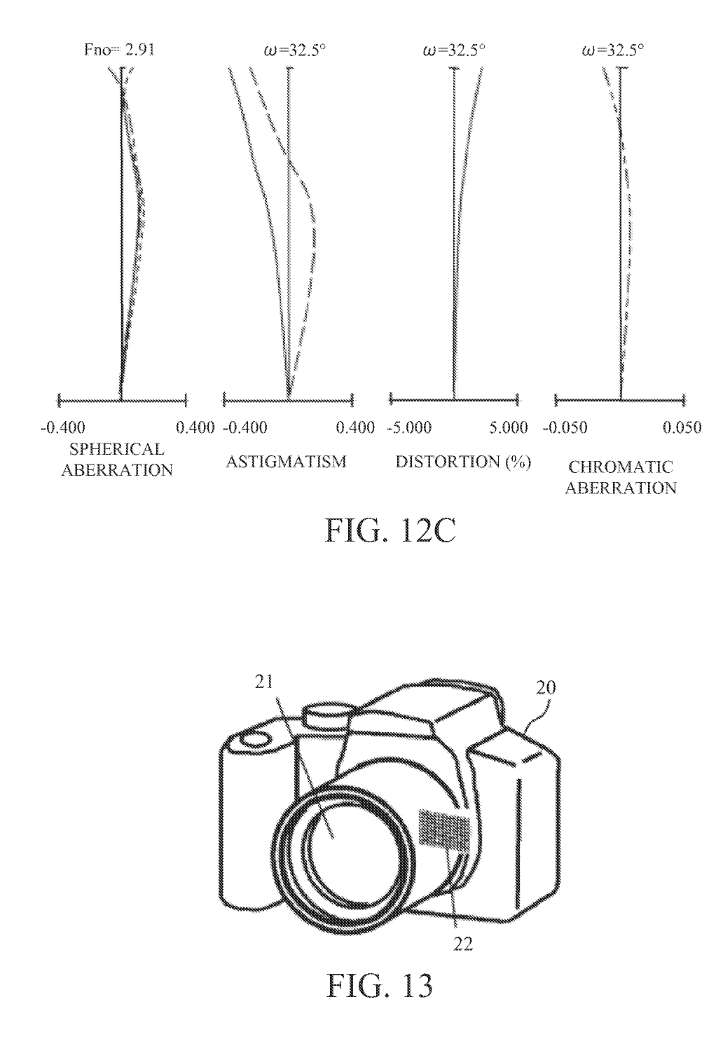

FIGS. 11A and 11B are sectional views of the zoom lens that is a sixth embodiment (Embodiment 6) at a wide-angle end and at a telephoto end, respectively. FIGS. 12A, 12B and 12C are aberration charts of the zoom lens of Embodiment 6 in a state where the zoom lens is focused on an infinite object at the wide-angle end, at a middle zoom position and at the telephoto end, respectively. The zoom lens has a zoom ratio of 2.06, an image capturing angle of view of 105.32° and an F-number of 2.91.

The zoom lens of each embodiment is used as an image capturing optical system for a camera (image pickup apparatus) shown in FIG. 13, such as a video camera, a digital still camera and a silver-haloid film camera.

In each sectional view of the zoom lens, a left side corresponds to an object side (front side), and a right side corresponds to an image side (rear side). Reference character Li denotes an i-th lens unit; i denotes a number in order from the object side. Reference character SP denotes an aperture stop. Reference character SSP denotes a fully opened F-number aperture stop, which changes its effective diameter (aperture diameter) with zooming to make its F-number constant or approximately constant in an entire zoom range. Reference character FC denotes a flare cutter (flare cutting stop) which cuts unnecessary light such as ghost and flare and cuts undesirable light such as coma flare in a peripheral image area.

Reference character IP denotes an image plane which corresponds to an image pickup plane of an image sensor (photoelectric conversion element) such as a CCD sensor or a CMOS sensor when the zoom lens is used as an image capturing optical system for a digital still camera, a video camera, a surveillance camera or which corresponds to a film surface when the zoom lens is used as an image capturing optical system for a silver-haloid film camera. Arrows below the lens units show movement loci of the respective lens units in zooming from the wide-angle end to the telephoto end (hereinafter referred to as “wide to telephoto zooming”).

In the aberration chart of spherical aberration, a solid line shows an aberration amount for a d-line, and a dashed-two dotted line shows an aberration amount for a g-line. A dotted line shows sine condition. In the aberration chart of astigmatism, a solid line shows a sagittal image plane, and a long dotted line shows a meridional image plane.

Chromatic aberration of magnification is shown by the g-line. Moreover, A represents a half angle of view, and Fno represents an F-number. In each embodiment, the wide-angle end and the telephoto end are zoom positions where lens units moved for variation of magnification are located at mechanical ends of their movable ranges in the optical axis direction.

In the wide to telephoto zooming, the first lens unit L1 is moved so as to draw a locus convex toward the image side as shown by the arrow below the first lens unit L1 to compensate for variation of the image plane IP with variation of magnification. The second, third and fourth lens units L2, L3 and L4 are lens units for variation of magnification, which are moved to the object side in the wide to telephoto zooming.

The first to fourth lens units L1 to L4 are moved in the wide to telephoto zooming such that, at the telephoto end, as compared with at the wide-angle end, a distance between the first and second lens units L1 and L2 becomes shorter, a distance between the second and third lens units L2 and L3 becomes longer, a distance between the third and fourth lens units L3 and L4 becomes shorter. The aperture stop SP is disposed on the object side further than the third lens unit L3 and is moved so as to draw a same locus as that of the third lens unit L3 in zooming. The aperture stop SP may be moved so as to draw a different locus from that of the third lens unit L3 in zooming

In each of Embodiments 1, 2, 5 and 6, the fully opened F-number aperture stop SSP is disposed on the image side further than the third lens unit L3 in order to maintain a fully opened F-number at a constant value. In Embodiment 3, the fully opened F-number aperture stop SSP is disposed on the image side further than the second lens unit L2.

In each of Embodiments 1 to 6, the flare cutter FC is disposed at a most-image side position, which enables cutting of an undesirable light component of a peripheral light flux at the telephoto end to achieve good optical performance at the telephoto end. In Embodiment 1, another flare cutter FC, which is moved so as to draw a different locus from those of the first to fourth lens units L1 to L4, is disposed between the first and second lens units L1 and L2. The other flare cutter FC cuts the undesirable light component in a middle zoom range to achieve good optical performance in the middle zoom range.

In each of Embodiments 1, 2 and 4 to 6, a sub lens unit L2F, which is an object side one of two sub lens units divided in the second lens unit L2, is moved to the image side for focusing on from an infinite object to a close distance object (hereinafter referred to as “infinity to close distance focusing). In Embodiment 3, a sub lens unit L1F, which is constituted by three image side lenses among lenses constituting the first lens unit L1, is moved to the object side for the infinity to close distance focusing. In the following description, twice an incident height of a maximum ray at a most object side lens surface of the first lens unit L1 is defined as a front lens effective diameter.

Next, description will be made of characteristics of the zoom lens of each embodiment. In general wide-angle lenses having an angle of view from about 60° to about 100°, aberration correction is more difficult than that in standard lenses having an angle of view from about 30° to about 60°. This is because the wide-angle lens has a retrofocus refractive power arrangement in its entire optical system in order to obtain a sufficient back focus.

In other words, the wide-angle lens has an asymmetric refractive power arrangement in which a lens having a negative refractive power and a lens having a positive refractive power are arranged in order from the object side with the aperture stop disposed therebetween. Such asymmetry of the refractive power arrangement increases as the angle of view increases, which results in generation of large aberrations such as distortion, chromatic aberration of magnification, field curvature, astigmatism and sagittal coma flare and thereby makes correction of these aberrations difficult.

In addition, increasing the angle of view ω decreases a peripheral light amount by the fourth power of cos ω, which makes it difficult to secure a sufficient peripheral light amount. In order to secure such a sufficient peripheral light amount, it is necessary to increase aperture efficiency as the angle of view increases, which increases coma aberration and difficulty of correction of the coma aberration. This also applies to the zoom lens, that is, the increase of the angle of view increases various aberrations and makes aberration correction difficult.

In particular, a zoom lens having a super wide image capturing angle of view exceeding 100° generates, at the wide-angle end, large distortion, large curved field and large astigmatism. Moreover, in order to miniaturize the entire zoom lens, it is necessary to decrease the front lens effective diameter thereof. In order to decrease the front lens effective diameter, it is necessary to dispose a lens unit having a strong negative refractive power on the object side to bring an entrance pupil position close to the most-object side lens surface (first lens surface). However, the miniaturization of the entire zoom lens further increases the asymmetry of the refractive power arrangement and thereby increases the various aberrations, which makes the aberration correction more difficult.

Therefore, in order to miniaturize the entire zoom lens and enable sufficient aberration correction, it is important to appropriately set a lens unit configuration and a refractive power arrangement in that lens unit configuration.

A four-lens-unit zoom lens constituted by lens units having negative, positive, negative and positive refractive powers more easily provides a high zoom ratio as compared with a two-lens-unit zoom lens constituted by lens units having negative and positive refractive powers since the four-lens-unit zoom lens includes more number of lens units contributing to variation of magnification than that of the two-lens-unit zoom lens. Moreover, such a four-lens-unit zoom lens more easily provides a refractive power arrangement in which the most-object side lens unit (first lens unit) has a strong negative refractive power as compared with the above two-lens-unit zoom lens since the four-lens-unit zoom lens includes more number of lens units contributing to aberration correction than that of the two-lens-unit zoom lens. The strong negative refractive power of the first lens unit brings the entrance pupil position close to the first lens surface and thereby enables decrease in the front lens effective diameter.

Thus, each of Embodiments 1 to 6 employs the four-lens-unit zoom lens having the above-mentioned lens unit configuration to decrease the front lens effective diameter.

On the other hand, the strong negative refractive power of the first lens unit generates a large amount of high-order off-axis aberration from the first lens unit, which makes it difficult to correct this aberration. Therefore, each of Embodiments 1 to 6 employs the following configuration of the first lens unit to sufficiently correct the high-order off-axis aberration while decreasing the front lens effective diameter.

In most general wide-angle zoom lenses, a lens surface on which off-axis rays has a large incident height is formed in an aspheric shape in order to correct distortion and field curvature at the wide-angle end. Specifically, an aspheric lens having an aspheric shape that decreases a negative refractive power from its center toward periphery is disposed on the object side further than the aperture stop, and an aspheric lens having an aspheric shape that decreases a positive refractive power from its center toward periphery is disposed on the image side further than the aperture stop. Increasing number of the aspheric lenses increases a freedom degree in aberration correction, which facilitates reduction of residual aberration.

However, aspheric lenses are difficult to be manufactured, and thereby it is not desirable to increase the number of the aspheric lenses. Accordingly, it is important to employ a lens configuration capable of providing a sufficient effect with a small number of the aspheric lenses.

As described above, the zoom lens of each embodiment includes, in order from the object side to the image side, the first lens unit L1 having a negative refractive power, the second lens unit L2 having a positive refractive power, the third lens unit L3 having a negative refractive power, and the fourth lens unit L4 having a positive refractive power. In the zoom lens of each embodiment, distances between mutually adjacent lens units among the first to fourth lens units L1 to L4 change during zooming. The first lens unit L1 includes, in order from the object side to the image side, a 1-1 lens having a meniscus shape whose convex surface faces the object side and having a negative refractive power, and a 1-2 lens having a meniscus shape whose convex surface faces the object side and having a negative refractive power. An image side surface of the 1-2 lens is formed in an aspheric shape that decreases a negative refractive power from its center toward periphery.

Moreover, the zoom lens of each embodiment satisfies the following conditions:

−4.0<f11/fw<−1.5 (1)

1.5<(R11b+R11a)/(R11b−R11a)<5.0 (2)

1.4<h12/D12<2.0 (3).

In the above conditions (1) to (3), f11 represents a focal length of the 1-1 lens, fw represents a focal length of the entire zoom lens at the wide-angle end, R11a and R11b respectively represent curvature radii of the object side convex surface and an image side concave surface of the 1-1 lens, h12 represents half of an effective diameter of the image side aspheric surface of the 1-2 lens, and D12 represents a distance in the optical axis direction from an effective diameter position in the image side aspheric surface of the 1-2 lens to an apex of the image side aspheric surface of the 1-2 lens.

Next, description will be made of technical meanings of each of the above-mentioned conditions (1) to (3). The condition (1) limits the focal length f11 of the 1-1 lens. It is advantageous for reduction of the front lens effective diameter to dispose a lens having a strong negative refractive power on the object side. Thus, each embodiment provides a sufficient negative power to the 1-1 lens. A lower value of f11/fw than the lower limit of the condition (1) exceedingly decreases the refractive power of the 1-1 lens, which makes it difficult to sufficiently reduce the front lens effective diameter. A higher value of f11/fw than the upper limit of the condition (1) is advantageous for the reduction of the front lens effective diameter but exceedingly increases the refractive power of the 1-1 lens and thereby causes a large amount of the off-axis aberration in the 1-1 lens, which makes it difficult to correct the off-axis aberration well even by using an aspheric surface.

The condition (2) limits a lens shape of the 1-1 lens. A lower value of (R11b+R11a)/(R11b−R11a) means that a curvature of the object side surface of the 1-1 lens becomes larger and a curvature of the image side surface thereof becomes smaller. A lower value of (R11b+R11a)/(R11b−R11a) than the lower limit of the condition (2) causes the object side surface of the 1-1 lens to have a strong negative refractive power, which provides a lens shape advantageous for the reduction of the front lens effective diameter but excessively increases an incident angle of off-axis rays on the object side surface and thereby undesirably results in generation of excessive negative distortion at the wide-angle end. On the other hand, a higher value of (R11b+R11a)/(R11b−R11a) than the upper limit of the condition (2) undesirably increases the front lens effective diameter.

The 1-2 lens has the meniscus shape whose convex surface faces the object side, satisfies the condition (3) and has the image side surface formed in the aspheric shape that decreases the negative refractive power from its center toward periphery. The 1-2 lens corrects negative distortion and field curvature generated in the 1-1 lens. The aspheric shape that decreases the negative refractive power from the center toward periphery provides a strong negative refractive power to the first lens unit L1 in its axial portion and on the contrary generates positive aberration in its off-axis portion so as to correct the negative off-axis aberration generated in the 1-1 lens.

Moreover, the aspheric shape is provided to the image side surface of the 1-2 lens. Since the 1-2 lens has the meniscus shape whose convex surface faces the object side, the image side surface has a smaller curvature radius than that of the object side surface. Accordingly, providing the aspheric shape to the image side surface makes it possible to form the above-mentioned aspheric shape that provides a stronger negative refractive power in the axial portion and on the contrary provides a positive refractive power in the off-axis portion.

Such an aspheric surface provides sufficient aberration correction effects, which facilitates appropriate correction of the distortion and the field curvature at the wide-angle end. Moreover, disposing the 1-2 lens on the image side further than the 1-1 lens reduces an effective diameter of the 1-2 lens, which facilitates manufacturing of the aspheric surface of the 1-2 lens and thereby achieves high shape accuracy.

The condition (3) limits the shape of the image side surface of the 1-2 lens. A higher value of h12/D12 than the upper limit of the condition (3) decreases an aperture angle of the image side surface of the 1-2 lens, which undesirably decreases the aberration correction effect of the aspheric surface. A lower value of h12/D12 than the lower limit of the condition (3) makes it necessary to provide a large space in the optical axis direction for disposing the 1-2 lens therein, which distances the entrance pupil position from the first lens unit L1 and thereby undesirably increases the front lens effective diameter.

It is desirable to set the numerical ranges of the conditions (1) to (3) as follows:

−3.2<f11/fw<−1.8 (1a)

2.0<(R11b+R11a)/(R11b−R11a)<3.8 (2a)

1.5<h12/D12<1.9 (3a).

It is more desirable that the zoom lens of each embodiment satisfy at least one of the following conditions:

−10.0<f12/fw<−1.0 (4)

1.8<N11<2.1 (5)

50.0<ν12<95.2 (6)

1.4<N4P<1.55 (7)

−1.4<f1/fw<−1.1 (8)

0.81<βRW×βRT<1.69 (9).

Satisfying each of the conditions (4) to (9) provides an effect corresponding thereto. In the above conditions (4) to (9), f12 represents a focal length of the 1-2 lens, N11 represents a refractive index of a material of the 1-1 lens, and ν12 represents an Abbe number of the material of the 1-2 lens. The fourth lens unit L4 includes a 4-1 lens having an object side convex surface and having a positive refractive power, and N4P represents a refractive index of a material of the 4-1 lens. Moreover, f1 represents a focal length of the first lens unit L1, and βRW and βRT respectively represent combined imaging lateral magnifications of all the lens units (L2 to L4) disposed on the image side further than the first lens unit L1 at the wide-angle end and the telephoto end.

Description will be made of technical meanings of each of the above-mentioned conditions (4) to (9).

The condition (4) limits the focal length f12 of the 1-2 lens. In order to suppression generation of various aberrations while providing a sufficient refractive power to the first lens unit L1, it is desirable that the 1-2 lens have an appropriate negative refractive power. Decrease of the negative refractive power of the 1-2 lens so as to make a value of f12/fw lower than the lower limit of the condition (4) makes it impossible to provide the appropriate negative refractive power to the first lens unit L1, which results in increase in the front lens effective diameter and thereby makes it difficult to increase the angle of view. On the other hand, increase of the negative refractive power of the 1-2 lens so as to make the value of f12/fw higher than the upper limit of the condition (4) undesirably increases negative aberration generated in the 1-2 lens.

The condition (5) limits the refractive index N11 of the material of the 1-1 lens. In order to suppress generation of various aberrations while providing an appropriate negative refractive power to the 1-1 lens, it is desirable to set the refractive index of the material of the 1-1 lens as high as possible. A lower refractive index N11 of the material of the 1-1 lens than the lower limit of the condition (5) makes it difficult to correct the various aberrations while reducing the front lens effective diameter. A higher value of the refractive index N11 of the material of the 1-1 lens than the upper limit of the condition (5) undesirably decreases appropriate materials that can be used as the material of the 1-1 lens.

The condition (6) limits the Abbe number ν12 of the material of the 1-2 lens. The 1-2 lens whose image side surface has an aspheric shape with a large aspheric amount corrects the distortion, the field curvature and others at the wide-angle end. Therefore, using a high dispersion material for the 1-2 lens changes the correction effect for the distortion and field curvature depending on wavelength. In other words, use of the high dispersion material for the 1-2 lens increases chromatic aberration of magnification and chromatic field curvature particularly at the wide-angle end. Accordingly, it is desirable to use as the material of the 1-2 lens a sufficiently low dispersion material.

Use of a high dispersion material for the 1-2 lens whose Abbe number ν12 is lower than the lower limit of the condition (6) undesirably increases the chromatic aberration of magnification and the chromatic field curvature. A higher Abbe number ν12 than the upper limit of the condition (6) undesirably decreases appropriate materials that can be used as the material of the 1-2 lens.

The condition (7) limits the refractive index N4P of the material of the 4-1 lens. Use of a material having a higher refractive index N4P than the upper limit of the condition (7) makes a Petzval sum large in its minus direction and thereby causes over field curvature in the entire zoom range. Moreover, the use of such a material having a high refractive index N4P decreases positive aberration generated at the object side convex surface of the 4-1 lens, which undesirably decreases an effect to cancel out residual aberration from the first lens unit L1. A lower refractive index N4P than the lower limit of the condition (7) undesirably decreases appropriate materials that can be used as the material of the 4-1 lens.

The condition (8) limits the focal length f1 of the first lens unit L1. A strong negative refractive power of the first lens unit L1 so as to make a value of f1/fw higher than the upper limit of the condition (8) undesirably makes it difficult to correct various aberrations generated in the first lens unit L1. A weak negative refractive power of the first lens unit L1 so as to make the value of f1/fw lower than the lower limit of the condition (8) undesirably increases the front lens effective diameter.

The condition (9) limits the imaging lateral magnification of a subsequent lens unit constituted by the lens units (L2 to L4) disposed on the image side further than the first lens unit L1.

In a two-lens-unit zoom lens constituted by lens units having negative and positive refractive powers, a value of βRW×βRT of 1.0 provides a so-called completely reciprocating zoom locus, and thereby entire lens lengths at the wide-angle end and the telephoto end coincide with each other. Completely or approximately completely reciprocating zoom loci generally facilitate balancing between miniaturization of the entire zoom lens and aberration correction. A large change of the value of βRW×βRT is advantageous for the miniaturization of the entire zoom lens but increases both the refractive powers of the first and subsequent lens units, which makes aberration correction difficult. On the other hand, a small change of the value of βRW×βRT provides a zoom locus moving the first lens unit L1 away from the subsequent lens unit toward the wide-angle end, which results in increase in the entire lens length and in the front lens effective diameter.

Similarly in the four-lens-unit zoom lens including the lens units having negative, positive, negative and positive refractive powers, a higher value of βRW×βRT than the upper limit of the condition (9) increases the entire lens length and the front lens effective diameter. On the other hand, a lower value of βRW×βRT than the lower limit of the condition (9) makes aberration correction difficult.

It is more desirable to set the numerical ranges of the conditions (4) to (9) as follows:

−4.0<f12/fw<−2.0 (4a)

1.85<N11<2.10 (5a)

56.0<ν12<95.2 (6a)

1.42<N4P<1.52 (7a)

−1.4>f1/fw<−1.2 (8a)

1.10<βRW×βRT<1.40 (9a).

As described above, each embodiment can provide a zoom lens having a maximum angle of view exceeding 100°, a zoom ratio of about 2×, good imaging performance from a central image area to a peripheral image area in its entire zoom range and a compact entire lens system.

In each embodiment, it is desirable that the first lens unit L1 include a 1-3 lens having a biconcave shape and having a negative refractive power on the image side further than the 1-2 lens and a 1-4 lens having a biconvex shape or a meniscus shape whose convex surface faces the object side and having a positive refractive power on the image side further than the 1-3 lens.

Providing the 1-3 lens causes multiple negative lenses to share the negative refractive power of the first lens unit L1, which facilitates suppression of the generation of the various aberrations. Moreover, a light flux diverged by the 1-1 and 1-2 lenses enters the 1-3 lens, so that the 1-3 lens more significantly influences axial aberration as compared with the 1-1 and 1-2 lenses. Therefore, providing the biconcave shape to the 1-3 lens facilitates correction of coma aberration at the telephoto end. Furthermore, the biconcave shape of the 1-3 lens provides a negative refractive power on its object side, which facilitates reduction of the front lens effective diameter.

The 1-4 lens mainly corrects chromatic aberration generated in the first lens unit L1. Disposing the 1-4 lens having a positive refractive power at a most-image side position in the first lens unit L1 causes a principal point of the first lens unit L1 to be located on the object side. This configuration facilitates the reduction of the front lens effective diameter. Moreover, providing the biconvex shape or the meniscus shape with the object side convex surface to the 1-4 lens facilitates sufficient correction of spherical aberration at the wide-angle and telephoto ends.

It is desirable to constitute the first lens unit L1 by four lens elements, that is, in order from the object side to the image side, a 1-1 lens, a 1-2 lens, a 1-3 lens and a 1-4 lens. Increasing number of negative lens elements makes it possible to cause the multiple negative lens elements to share the negative refractive power of the first lens unit L1. However, an excessively large number of the negative lens elements needs a large space for disposing the lens elements therein, which undesirably increases the front lens effective diameter.

In each embodiment, a lens having a negative refractive power may be disposed between the 1-2 lens and the 1-3 lens. This configuration further facilitates the correction of the various aberrations. Furthermore, providing two or more aspheric surfaces to the first lens unit L1 facilitates aberration correction.

It is desirable that the fourth lens unit L4 include the 4-1 lens having the object side convex surface and having a positive refractive power and that at least one aspheric surface that decreases a positive refractive power from its center toward periphery on the image side further than the 4-1 lens. Since an incident height of axial rays on the fourth lens unit L4 is high, appropriate setting of the configuration of the fourth lens unit L4 facilitates canceling out of the residual aberration from the first lens unit L1. Causing the object side lens surface of the 4-1 lens to generate positive aberration facilitates correction of field curvature at the wide-angle end.

On the other hand, the convex surface of the 4-1 lens generates negative distortion at the wide-angle end. Thus, it is desirable that the fourth lens unit L4 include at least one aspheric surface that decreases a positive refractive power from its center toward periphery. This aspheric surface facilitates canceling out of the negative distortion generated in the 4-1 lens. Moreover, it is desirable that the aspheric surface be disposed on the image side further than the 4-1 lens.

In the fourth lens unit L4, an incident height of off-axis rays is higher on the image side than that on the object side. Therefore, providing the aspheric surface on the image side than the 4-1 lens facilitates correction of the negative aberration generated in the 4-1 lens. Combination of these object side convex surface of the 4-1 lens and the aspheric surface disposed on the image side further than the 4-1 lens enables the fourth lens unit L4 to sufficiently cancel out the residual aberration from the first lens unit L1, which makes it possible to easily achieve a zoom lens having high optical performance in its entire zoom range.

Next, description will be made of the above-mentioned image pickup apparatus (camera) shown in FIG. 13, which is another embodiment of the present invention. In FIG. 13, reference numeral 20 denotes a camera body, 21 an image capturing optical system constituted by any one of the zoom lenses shown in Embodiments 1 to 6. Reference numeral 22 denotes a solid-state image sensor (photoelectric conversion element) that is provided inside the camera body 22 and receives an object image formed by the image capturing optical system 21. The zoom lens of each embodiment can be used with a single-lens reflex camera provided with a quick return mirror and with a mirror-less camera provided with no quick return mirror.

Specific numerical data of Numerical Examples 1 to 6 respectively corresponding to Embodiments 1 to 6 are shown below. In the data, i denotes a number of each surface counted from the object side, ri denotes a curvature radius of the i-th surface (optical surface), di denotes an axial distance between the i-th surface and an (i+1)-th surface, and ndi and νdi respectively denote a refractive index and an Abbe number of a material of an i-th optical element for a d-line. Moreover, ω denotes a half angle of view. In Numerical Examples 5 and 6, a value of d28 has a minus sign because a rear-most lens surface of the fourth lens unit L4 and the flare cutter (FC) are counted in this order.

An aspheric shape is expressed by the following expression where a direction of light traveling in the zoom lens is defined as positive, x represents a displacement amount from a surface apex in the optical axis direction, h represents a height from an optical axis in a direction orthogonal to the optical axis direction, r represent a paraxial curvature radius, K represent a conic constant, and A4, A6, A8, A10 and A12 represent aspheric coefficients.

x=(h²/r)/{1+[1−(1+K)×(h/r)²]^{1/2}}+A4×h⁴+A6×h⁶+A8×h⁸+A10×h¹⁰+A12×h¹².

In addition, “e±XX” in each aspheric coefficient means “×10±^{XX}”. Table 1 shows relations between the above-described conditions and Numerical Examples 1 to 6.

### Numerical Example 1

Surface Data

| Surface | | | | |
|---|---|---|---|---|
| No. | r | d | nd | νd |
| 1* | 54.141 | 2.30 | 2.00330 | 28.3 |
| 2 | 19.098 | 5.03 | | |
| 3 | 28.535 | 1.80 | 1.55332 | 71.7 |
| 4* | 14.828 | 10.14 | | |

Maximum ray effective diameter 27.995

| | | | | |
|---|---|---|---|---|
| 5 | −52.774 | 1.38 | 1.84222 | 43.7 |
| 6 | 58.350 | 0.10 | | |
| 7 | 38.661 | 7.14 | 1.78471 | 26.0 |
| 8 | −69.103 | (variable) | | |
| 9 | ∞(FC) | (variable) | | |
| 10 | 36.541 | 1.20 | 1.80809 | 22.8 |
| 11 | 17.199 | 5.20 | 1.65412 | 39.7 |
| 12 | −119.313 | 3.77 | | |
| 13 | 59.375 | 3.00 | 1.53084 | 49.7 |
| 14 | −86.123 | (variable) | | |
| 15 (SP) | ∞(SP) | 1.87 | | |
| 16 | −55.769 | 0.98 | 1.88300 | 40.8 |
| 17 | 146.713 | 1.11 | | |
| 18 | −47.251 | 0.98 | 1.71807 | 32.0 |
| 19 | 22.061 | 5.40 | 1.80809 | 22.8 |
| 20 | −66.101 | 1.03 | | |
| 21 | ∞(SSP) | (variable) | | |
| 22 | 18.559 | 5.58 | 1.49700 | 81.5 |
| 23 | −69.646 | 0.15 | | |
| 24 | 70.943 | 1.00 | 1.91082 | 35.3 |
| 25 | 16.382 | 6.80 | 1.43875 | 94.9 |
| 26 | −28.941 | 1.40 | 1.90366 | 31.3 |
| 27* | −58.704 | (variable) | | |
| 28 | ∞(FC) | 38.60 | | |
| IP | ∞ | | | |

Aspheric Data

| | | |
|---|---|---|
| First Surface | | |
| K = 0.00000e+000 | A4 = 1.05663e−005 | A6 = −2.23229e−008 |
| A8 = 3.54933e−011 | A10 = −3.56386e−014 | A12 = 1.69771e−017 |
| Fourth Surface | | |
| K = −6.23758e−001 | A4 = 2.15179e−005 | A6 = −3.90684e−008 |
| A8 = −3.78682e−011 | A10 = −3.08104e−013 | |
| 27th Surface | | |
| K = −1.02862e+001 | A4 = 1.54094e−005 | A6 = 8.15661e−008 |
| A8 = −1.49125e−011 | A10 = 3.05979e−012 | |

| | Wide | Middle | Tele |
|---|---|---|---|
| Focal Length | 16.49 | 23.55 | 33.95 |
| F-number | 4.10 | 4.10 | 4.10 |
| Half Angle of | 52.68 | 42.57 | 32.51 |
| View | | | |
| d8 | 18.02 | 7.45 | 1.00 |
| d9 | 7.76 | 4.69 | 1.91 |
| d14 | 1.00 | 4.06 | 6.84 |
| d21 | 7.59 | 4.69 | 0.99 |
| d27 | 0.00 | 8.66 | 22.60 |

### Numerical Example 2

Surface Data

| Surface | | | | |
|---|---|---|---|---|
| No. | r | d | nd | νd |
| 1 | 49.356 | 2.30 | 1.88300 | 40.8 |
| 2 | 19.879 | 5.74 | | |
| 3* | 26.583 | 1.80 | 1.56907 | 71.3 |
| 4* | 13.569 | 12.79 | | |

Maximum ray effective diameter 30.241

| | | | | |
|---|---|---|---|---|
| 5 | −45.928 | 1.38 | 1.88300 | 40.8 |
| 6 | 86.702 | 0.10 | | |
| 7 | 52.839 | 5.70 | 1.80610 | 33.3 |
| 8 | −52.421 | (variable) | | |
| 9 | 37.202 | 1.20 | 1.64769 | 33.8 |
| 10 | 18.497 | 5.20 | 1.51633 | 64.1 |
| 11 | −110.541 | 5.23 | | |
| 12 | 53.907 | 3.00 | 1.61772 | 49.8 |
| 13 | −92.097 | (variable) | | |
| 14 (SP) | ∞(SP) | 1.87 | | |
| 15 | −58.306 | 1.25 | 1.72000 | 50.2 |
| 16 | 73.221 | 1.50 | | |
| 17 | −73.034 | 1.00 | 1.62230 | 53.2 |
| 18 | 29.316 | 2.68 | 1.80518 | 25.4 |
| 19 | −287.926 | 1.00 | | |
| 20 | ∞(SSP) | (variable) | | |
| 21 | 18.131 | 5.10 | 1.49700 | 81.5 |
| 22 | −59.994 | 0.15 | | |
| 23 | 158.125 | 1.00 | 1.85026 | 32.3 |
| 24 | 16.262 | 8.38 | 1.43875 | 94.9 |
| 25 | −18.696 | 1.00 | 1.77250 | 49.6 |
| 26* | −59.868 | 1.20 | | |
| 27 | −39.582 | 2.00 | 1.59270 | 35.3 |
| 28 | −27.911 | (variable) | | |
| 29 | ∞(FC) | 38.77 | | |
| IP | ∞ | | | |

Aspheric Data

| | | |
|---|---|---|
| Third Surface | | |
| K = 0.00000e+000 | A4 = 8.94698e−006 | A6 = −5.47169e−008 |
| A8 = 7.42531e−011 | A10 = −6.65369e−014 | A12 = 3.59356e−018 |
| Fourth Surface | | |
| K = −1.06408e+000 | A4 = 2.71687e−005 | A6 = −7.10426e−008 |
| A8 = −3.48660e−011 | A10 = −2.52192e−014 | |
| 26th Surface | | |
| K = 0.00000e+000 | A4 = 2.34940e−005 | A6 = 5.91184e−008 |
| A8 = 1.76050e−010 | A10 = 1.48754e−012 | |

| | Wide | Middle | Tele |
|---|---|---|---|
| Focal Length | 17.50 | 25.45 | 38.90 |
| F-number | 4.10 | 4.10 | 4.10 |
| Half Angle of | 51.03 | 40.36 | 29.08 |
| View | | | |
| d8 | 30.31 | 13.22 | 1.04 |
| d13 | 1.00 | 3.41 | 7.28 |
| d20 | 7.27 | 4.85 | 0.99 |
| d28 | 0.10 | 9.90 | 25.61 |

### Numerical Example 3

Surface Data

| Surface | | | | |
|---|---|---|---|---|
| No. | r | d | nd | νd |
| 1* | 32.440 | 2.10 | 1.88300 | 40.8 |
| 2 | 18.806 | 8.22 | | |
| 3 | 23.807 | 1.64 | 1.56907 | 71.3 |
| 4* | 11.246 | 11.75 | | |

Maximum ray effective diameter 28.254

| | | | | |
|---|---|---|---|---|
| 5 | −47.705 | 1.26 | 1.88300 | 40.8 |
| 6 | 68.791 | 0.09 | | |
| 7 | 50.874 | 5.20 | 1.80610 | 33.3 |
| 8 | −53.561 | (variable) | | |
| 9 | ∞(SSP) | 0.74 | | |
| 10 | 31.557 | 1.20 | 1.69895 | 30.1 |
| 11 | 17.216 | 5.33 | 1.56883 | 56.4 |
| 12 | −275.882 | 0.18 | | |
| 13 | 42.262 | 3.41 | 1.53996 | 59.5 |
| 14 | −195.796 | (variable) | | |
| 15(SP) | ∞(SP) | 1.87 | | |
| 16 | −118.291 | 1.25 | 1.57250 | 57.7 |
| 17 | 134.631 | 1.20 | | |
| 18 | −58.702 | 1.00 | 1.83481 | 42.7 |
| 19 | 17.104 | 3.91 | 1.80000 | 29.8 |
| 20 | −161.942 | (variable) | | |
| 21 | 24.571 | 7.20 | 1.43875 | 94.9 |
| 22 | −28.275 | 0.13 | | |
| 23* | −189.886 | 1.50 | 1.80100 | 35.0 |
| 24 | 20.325 | 7.50 | 1.49700 | 81.5 |
| 25 | −62.584 | (variable) | | |
| 26 | ∞(FC) | 39.49 | | |
| IP | ∞ | | | |

Aspheric Data

| | | |
|---|---|---|
| First Surface | | |
| K = 0.00000e+000 | A4 = −6.22626e−006 | A6 = 6.85081e−009 |
| A8 = −2.71276e−011 | A10 = 4.34967e−014 | A12 = −2.88535e−017 |
| Fourth Surface | | |
| K = −1.31793e+000 | A4 = 3.47755e−005 | A6 = −5.36676e−008 |
| A8 = −1.50887e−010 | A10 = −2.08775e−013 | |
| 23rd Surface | | |
| K = 0.00000e+000 | A4= −1.85231e−005 | A6 = −1.83917e−008 |
| A8 = −7.98144e−011 | A10 = 3.08747e−013 | |

| | Wide | Middle | Tele |
|---|---|---|---|
| Focal Length | 17.51 | 26.00 | 38.89 |
| F-number | 4.10 | 4.10 | 4.10 |
| Half Angle of | 51.02 | 39.76 | 29.09 |
| View | | | |
| d8 | 24.10 | 9.63 | 1.00 |
| d14 | 1.09 | 6.06 | 13.08 |
| d20 | 12.27 | 7.60 | 1.00 |
| d25 | 0.00 | 8.82 | 21.33 |

### Numerical Example 4

Surface Data

| Surface | | | | |
|---|---|---|---|---|
| No. | r | d | nd | νd |
| 1* | 40.042 | 2.30 | 1.88300 | 40.8 |
| 2 | 20.447 | 5.08 | | |
| 3 | 26.219 | 1.80 | 1.56907 | 71.3 |
| 4* | 12.462 | 13.07 | | |

Maximum ray effective diameter 30.648

| | | | | |
|---|---|---|---|---|
| 5 | −46.779 | 1.30 | 1.88300 | 40.8 |
| 6 | 63.275 | 0.10 | | |
| 7 | 46.630 | 6.70 | 1.80610 | 33.3 |
| 8 | −57.444 | (variable) | | |
| 9 | 38.137 | 1.20 | 1.66680 | 33.0 |
| 10 | 18.662 | 5.20 | 1.52249 | 59.8 |
| 11 | −120.078 | 4.78 | | |
| 12 | 46.717 | 3.00 | 1.53172 | 48.8 |
| 13 | −85.014 | (variable) | | |
| 14 (SP) | ∞(SP) | 1.87 | | |
| 15 | −95.443 | 1.25 | 1.72000 | 50.2 |
| 16 | 110.341 | 1.50 | | |
| 17 | −54.750 | 1.00 | 1.62230 | 53.2 |
| 18 | 32.587 | 2.68 | 1.80518 | 25.4 |
| 19 | −761.133 | (variable) | | |
| 20 | 21.218 | 5.50 | 1.59282 | 68.6 |
| 21 | −52.860 | 0.15 | | |
| 22 | −332.218 | 0.80 | 1.85026 | 32.3 |
| 23 | 17.588 | 8.31 | 1.43875 | 94.9 |
| 24 | −18.406 | 1.00 | 1.77250 | 49.6 |
| 25* | −77.024 | 0.50 | | |
| 26 | −96.193 | 2.50 | 1.59270 | 35.3 |
| 27 | −31.394 | (variable) | | |
| 28 | ∞(FC) | 38.91 | | |
| IP | ∞ | | | |

Aspheric Data

| | | |
|---|---|---|
| First Surface | | |
| K = 0.00000e+000 | A4 = −3.74410e−006 | A6 = 2.96363e−009 |
| A8 = −7.89797e−012 | A10 = 1.11485e−014 | A12 = −6.45723e−018 |
| Fourth Surface | | |
| K = −1.39682e+000 | A4 = 3.65975e−005 | A6 = −5.06771e−008 |
| A8 = 5.98316e−011 | A10 = −2.38695e−013 | |
| 25th Surface | | |
| K = 0.00000e+000 | A4 = 1.86311e−005 | A6 = 3.18612e−008 |
| A8 = 1.03417e−010 | A10 = 2.29990e−013 | |

| | Wide | Middle | Tele |
|---|---|---|---|
| Focal Length | 17.50 | 24.82 | 38.89 |
| F-number | 2.88 | 3.25 | 4.10 |
| Half Angle of | 51.02 | 41.08 | 29.09 |
| View | | | |
| d8 | 28.07 | 13.05 | 1.05 |
| d13 | 1.00 | 4.36 | 9.76 |
| d19 | 10.67 | 7.31 | 1.91 |
| d27 | 0.19 | 8.91 | 25.63 |

### Numerical Example 5

Surface Data

| Surface | | | | |
|---|---|---|---|---|
| No. | r | d | nd | νd |
| 1* | 56.498 | 2.27 | 1.88300 | 40.8 |
| 2 | 22.367 | 2.87 | | |
| 3 | 27.000 | 1.78 | 1.58313 | 59.4 |
| 4* | 14.050 | 12.33 | | |

Maximum ray effective diameter 30.777

| | | | | |
|---|---|---|---|---|
| 5 | −49.883 | 1.36 | 1.83481 | 42.7 |
| 6 | 50.828 | 0.10 | | |
| 7 | 41.815 | 6.31 | 1.69895 | 30.1 |
| 8 | −58.868 | (variable) | | |
| 9 | 39.493 | 1.30 | 1.84666 | 23.9 |
| 10 | 23.024 | 8.00 | 1.51742 | 52.4 |
| 11 | −87.485 | 3.82 | | |
| 12 | 39.960 | 5.18 | 1.51742 | 52.4 |
| 13 | −78.985 | (variable) | | |
| 14 (SP) | ∞(SP) | 1.90 | | |
| 15 | −2733.120 | 1.40 | 1.88300 | 40.8 |
| 16 | 105.790 | 2.36 | | |
| 17 | −46.812 | 1.10 | 1.80440 | 39.6 |
| 18 | 21.184 | 5.50 | 1.84666 | 23.8 |
| 19 | −330.145 | 1.23 | | |
| 20 | ∞(SSP) | (variable) | | |
| 21 | 32.261 | 8.60 | 1.49700 | 81.5 |
| 22 | −22.035 | 1.20 | 1.84666 | 23.9 |
| 23 | −35.311 | 0.20 | | |
| 24 | 118.672 | 1.20 | 1.83400 | 37.2 |
| 25 | 21.828 | 6.40 | 1.49700 | 81.5 |
| 26 | 108.462 | 0.20 | | |
| 27 | 63.724 | 3.40 | 1.58313 | 59.4 |
| 28* | −137.932 | (variable) | | |
| 29 | ∞(FC) | 38.97 | | |
| IP | ∞ | | | |

Aspheric Data

| | | |
|---|---|---|
| First Surface | | |
| K = 0.00000e+000 | A4 = 5.37879e−007 | A6 = 2.50550e−009 |
| A8 = −1.03658e−011 | A10 = 1.43365e−014 | A12 = −7.25900e−018 |
| Fourth Surface | | |
| K = −1.28331e+000 | A4 = 2.65181e−005 | A6 = −2.92796e−009 |
| A8 = 3.91989e−013 | A10 = −1.98199e−014 | |
| 28th Surface | | |
| K = −1.00341e+001 | A4 = 1.00235e−005 | A6 = 1.73133e−009 |
| A8 = 5.52840e−011 | A10 = −8.42415e−014 | |

| | Wide | Middle | Tele |
|---|---|---|---|
| Focal Length | 16.50 | 25.34 | 34.00 |
| F-number | 2.91 | 2.91 | 2.91 |
| Half Angle of | 52.66 | 40.49 | 32.47 |
| View | | | |
| d8 | 23.73 | 7.89 | 1.26 |
| d13 | 0.90 | 6.67 | 11.28 |
| d20 | 10.85 | 5.07 | 0.47 |
| d28 | −0.23 | 10.50 | 21.24 |

### Numerical Example 6

Surface Data

| Surface | | | | |
|---|---|---|---|---|
| No. | r | d | nd | νd |
| 1 | 55.265 | 2.27 | 1.88300 | 40.8 |
| 2 | 22.966 | 2.43 | | |
| 3 | 27.000 | 1.90 | 1.58313 | 59.4 |
| 4* | 13.427 | 12.78 | | |

Maximum ray effective diameter 30.637

| | | | | |
|---|---|---|---|---|
| 5* | −49.434 | 1.36 | 1.82766 | 43.4 |
| 6 | 57.155 | 0.10 | | |
| 7 | 43.118 | 6.14 | 1.68767 | 31.2 |
| 8 | −59.777 | (variable) | | |
| 9 | 38.632 | 1.30 | 1.84513 | 25.2 |
| 10 | 22.612 | 7.26 | 1.52383 | 51.1 |
| 11 | −90.638 | 3.83 | | |
| 12 | 42.944 | 4.58 | 1.51727 | 53.7 |
| 13 | −81.645 | (variable) | | |
| 14 (SP) | ∞(SP) | 1.90 | | |
| 15 | −3585.406 | 1.40 | 1.88300 | 40.8 |
| 16 | 119.979 | 2.36 | | |
| 17 | −47.296 | 1.10 | 1.80094 | 39.6 |
| 18 | 21.503 | 5.50 | 1.84666 | 23.8 |
| 19 | −482.287 | 1.23 | | |
| 20 | ∞(SSP) | (variable) | | |
| 21 | 32.248 | 8.50 | 1.49700 | 81.5 |
| 22 | −22.347 | 1.20 | 1.84666 | 23.9 |
| 23 | −35.316 | 0.20 | | |
| 24 | 135.243 | 1.20 | 1.83400 | 37.2 |
| 25 | 21.812 | 6.95 | 1.49700 | 81.5 |
| 26 | 102.138 | 0.20 | | |
| 27 | 60.051 | 2.90 | 1.58313 | 59.4 |
| 28* | −112.334 | (variable) | | |
| 29 | ∞(FC) | 38.98 | | |
| IP | ∞ | | | |

Aspheric Data

| | | |
|---|---|---|
| Fourth Surface | | |
| K = −1.12190e+000 | A4 = 2.13973e−005 | A6 = −1.46785e−008 |
| A8 = 9.71836e−011 | A10 = −1.11194e−013 | |
| Fifth Surface | | |
| K = 1.26986e−001 | A4 = −6.13176e−007 | A6 = 9.80499e−011 |
| A8 = 2.01874e−012 | A10 = −1.41944e−014 | |
| 28th Surface | | |
| K = −1.05433e+001 | A4 = 9.54547e−006 | A6 = −1.53662e−010 |
| A8 = 6.26557e−011 | A10 = −1.00401e−013 | |

| | Wide | Middle | Tele |
|---|---|---|---|
| Focal Length | 16.51 | 25.42 | 34.00 |
| F-number | 2.91 | 2.91 | 2.91 |
| Half Angle of | 52.66 | 40.40 | 32.47 |
| View | | | |
| d8 | 23.49 | 7.58 | 1.00 |
| d13 | 0.90 | 6.83 | 11.33 |
| d20 | 10.63 | 4.70 | 0.20 |
| d28 | −0.19 | 10.66 | 21.51 |

TABLE 1

| | | Condition | | | | | | | | |
|---|---|---|---|---|---|---|---|---|---|---|
| | | | (2) | | | | | | | |
| | | (1) | (R11b + R11a)/ | (3) | (4) | (5) | (6) | (7) | (8) | (9) |
| | | f11/fw | (R11b − T11a) | h12/D12 | f12/fw | N11 | ν12 | N4p | f1/fw | βRW × βRT |
| Numerical | 1 | −1.84 | 2.09 | 1.83 | −3.55 | 2.00 | 71.7 | 1.50 | −1.29 | 1.24 |
| Example | 2 | −2.24 | 2.35 | 1.73 | −2.93 | 1.88 | 71.3 | 1.50 | −1.38 | 1.17 |
| | 3 | −3.12 | 3.76 | 1.62 | −2.25 | 1.88 | 71.3 | 1.44 | −1.30 | 1.32 |
| | 4 | −2.86 | 3.09 | 1.58 | −2.50 | 1.88 | 71.3 | 1.50 | −1.33 | 1.27 |
| | 5 | −2.62 | 2.31 | 1.66 | −3.21 | 1.88 | 59.4 | 1.50 | −1.28 | 1.25 |
| | 6 | −2.79 | 2.42 | 1.59 | −2.93 | 1.88 | 59.4 | 1.50 | −1.30 | 1.21 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-183147, filed Aug. 22, 2012, which is hereby incorporated by reference herein in its entirety.

What is claimed is:

1. A zoom lens comprising in order from an object side to an image side:
a first lens unit having a negative refractive power;
a second lens unit having a positive refractive power;
a third lens unit having a negative refractive power; and
a fourth lens unit having a positive refractive power,
wherein distances between mutually adjacent lens units among the first to fourth lens units change during zooming,
wherein the first lens unit includes, in order from the object side to the image side, a 1-1 lens having a meniscus shape whose convex surface faces the object side and having a negative refractive power, and a 1-2 lens having a meniscus shape whose convex surface faces the object side and having a negative refractive power, an image side surface of the 1-2 lens being formed in an aspheric shape that decreases a negative refractive power from its center toward periphery, and
wherein the following conditions are satisfied:
−4.0<f11/fw<−1.5
1.5<(R11b+R11a)/(R11b−R11a)<5.0
1.4<h12/D12<2.0
where f11 represents a focal length of the 1-1 lens, fw represents a focal length of the entire zoom lens at a wide-angle end, R11a and R11b respectively represent curvature radii of the object side convex surface and an image side concave surface of the 1-1 lens, h12 represents half of an effective diameter of the image side aspheric surface of the 1-2 lens, and D12 represents a distance in an optical axis direction from an effective diameter position in the image side aspheric surface of the 1-2 lens to an apex of the image side aspheric surface of the 1-2 lens.

2. A zoom lens according to claim 1, wherein the following condition is satisfied:
−10.0<f12/fw<−1.0
where f12 represents a focal length of the 1-2 lens.

3. A zoom lens according to claim 1, wherein the following conditions are satisfied:
1.8<N11<2.1
50.0<ν12<95.2
where N11 represents a refractive index of a material of the 1-1 lens, and ν12 represents an Abbe number of a material of the 1-2 lens.

4. A zoom lens according to claim 1, wherein the fourth lens unit includes a 4-1 lens having an object side convex surface and having a positive refractive power, and
wherein the following condition is satisfied:
1.4<N4P<1.55
where N4P represents a refractive index of a material of the 4-1 lens.

5. A zoom lens according to claim 1, wherein the following condition is satisfied:
−1.4<f1/fw<−1.1
where f1 represents a focal length of the first lens unit.

6. A zoom lens according to claim 1, wherein the following condition is satisfied:
0.81<βRW×βRT<1.69
where βRW and βRT respectively represent combined imaging lateral magnifications of all lens units disposed on the image side further than the first lens unit at the wide-angle end and at a telephoto end.

7. A zoom lens according to claim 1, wherein the first lens unit includes a 1-3 lens having a biconcave shape and having a negative refractive power on the image side further than the 1-2 lens, and a 1-4 lens having a biconvex shape and having a positive refractive power on the image side further than the 1-3 lens.

8. A zoom lens according to claim 1, wherein the first lens unit consists of four lens elements.

9. A zoom lens according to claim 1, wherein the first lens unit includes two or more aspheric surfaces.

10. A zoom lens according to claim 1, wherein the fourth lens unit includes, in order from the object side to the image side, a 4-1 lens having an convex object side surface and having a positive refractive power, and at least one aspheric surface disposed on the image side further than 4-1 lens and having an aspheric shape that decreases a positive refractive power from its center toward periphery.

11. An image pickup apparatus comprising:
a zoom lens; and
an image sensor receiving an object image formed by the zoom lens,
wherein the zoom lens comprises in order from an object side to an image side:
a first lens unit having a negative refractive power;
a second lens unit having a positive refractive power;
a third lens unit having a negative refractive power; and
a fourth lens unit having a positive refractive power,
wherein distances between mutually adjacent lens units among the first to fourth lens units change during zooming,
wherein the first lens unit includes, in order from the object side to the image side, a 1-1 lens having a meniscus shape whose convex surface faces the object side and having a negative refractive power, and a 1-2 lens having a meniscus shape whose convex surface faces the object side and having a negative refractive power, an image side surface of the 1-2 lens being formed in an aspheric shape that decreases a negative refractive power from its center toward periphery, and
wherein the following conditions are satisfied:
−4.0<f11/fw<−1.5
1.5<(R11b+R11a)/(R11b−R11a)<5.0
1.4<h12/D12<2.0
where f11 represents a focal length of the 1-1 lens, fw represents a focal length of the entire zoom lens at a wide-angle end, R11a and R11b respectively represent curvature radii of the object side convex surface and an image side concave surface of the 1-1 lens, h12 represents half of an effective diameter of the image side aspheric surface of the 1-2 lens, and D12 represents a distance in an optical axis direction from an effective diameter position in the image side aspheric surface of the 1-2 lens to an apex of the image side aspheric surface of the 1-2 lens.
